(19) United States
(12) Patent Application Publication
(10) Pub. No.: US 2024/0197114 A1
(43) Pub. Date: Jun. 20, 2024

(54) Portable Grill System with Katabatic Dampers

(71) Applicant: Fire & Flavor Grilling Co. LLC, Athens, GA (US)

(72) Inventors: Davis Purcell Knox, Athens, GA (US); Cole Robert Fungaroli, New Paris, PA (US)

(73) Assignee: Fire & Flavor Grilling Co. LLC, Athens, GA (US)

(21) Appl. No.: 18/544,088

(22) Filed: Dec. 18, 2023

Related U.S. Application Data
(60) Provisional application No. 63/433,271, filed on Dec. 16, 2022.

(51) Int. Cl. A47J 37/07

(52) U.S. Cl. CPC A47J 37/0704

(57) ABSTRACT

Disclosed is a portable grilling system that leverages katabatic-induced air flows through side vents. Embodiments of the solution are configured such that air flows are encouraged with a damper and vent arrangement that promotes katabatic forces. Advantageously, by bringing the air flows into the combustion chamber of the lower bowl or grill body, the air flows may be directed to wash across, both above and beneath, a combusting solid fuel source, such as a coal bed. In this way, hot spots in the center of the coal bed (or anywhere) are mitigated, thereby improving temperature management during cooking. Additionally, because the intake damper vents are located in the side of the lower bowl, as opposed to in the bottom of the lower bowl like in prior art solutions, ash falling from the fuel grate may be captured in a removable ash bowl without interfering with damper settings and air flows.

### CROSS-REFERENCE TO RELATED APPLICATIONS

This claims priority under 35 U.S.C. § 119(e) to U.S. provisional application entitled “IMPROVED PORTABLE GRILL SYSTEM WITH KATABATIC DAMPERS,” filed on Dec. 16, 2022 and assigned application Ser. No. 63/433,271, the entire contents of which are hereby incorporated by reference.

### BACKGROUND

Kettle-styled grills known in the art typically include a lower bowl and a lid. The lower bowl houses a fuel grate and a cooking grate. The fuel grate is positioned beneath the cooking grate such that thermal energy generated by combusting fuel residing on the fuel grate may rise to the cooking grate and thereby cook any foodstuff thereon, as would be understood by one of ordinary skill in the art of kettle grills. To manage the combustion process, dampers are typically located centrally in the base of the lower bowl such that air entering through the dampers may rise up through the fuel bed (typically coal) on the fuel grate and encourage combustion. Subsequently, smoke, and hot air rises from the combusting fuel bed, through the cooking grate (as previously described), and out an upper damper system and/or chimney positioned at the top of the lid.

Various problems and challenges are associated with these kettle-styled grills known in the art. For example, because air is brought into the grill from a damper located in the base of the lower bowl, ash falling from the fuel grate tends to clog the air intake dampers creating a constant need to remove ash and clear a path for incoming air. Another problem associated with prior art designs for kettle-styled grills that locate the air intake damper in the base of the lower bowl is that hot spots in the center of the fuel bed are promoted as the air simply rises directly up to meet the combusting fuel bed without any encouragement toward the edges of the fuel bed. Yet another problem is the skill and expertise required to manage cooking temperature and smoke distribution through coordinated manipulation of the lower dampers and upper dampers/chimney.

Therefore, there is a need in the art for an improved portable grill system that addresses the above articulated problems in the art as well as other problems. More particularly, there is a need in the art for an improved portable grill system that leverages katabatic-induced air flows through side vents in a lower bowl of a kettle-styled grill.

### SUMMARY

Exemplary embodiments of a novel and improved portable grilling system that leverages katabatic-induced air flows through side vents are disclosed. Embodiments of the solution are configured such that air flows are encouraged with a damper and vent arrangement that promotes katabatic forces. Advantageously, by bringing the air flows into the combustion chamber of the lower bowl or grill body, the air flows may be directed to wash across, both above and beneath, a combusting solid fuel source, such as a coal bed. In this way, hot spots in the center of the coal bed (or anywhere) are mitigated, thereby improving temperature management during cooking. Additionally, and advantageously, because the intake damper vents are located in the side of the lower bowl, as opposed to in the bottom of the lower bowl like in prior art solutions, ash falling from the fuel grate may be captured in a removable ash bowl without interfering with damper settings and air flows.

An exemplary embodiment of the solution includes a kettle having an upper body and a lower body, wherein the lower body defines a combustion chamber. A fuel grate is mounted within the combustion chamber for supporting a solid fuel source. The upper body defines a cooking chamber and supports a cooking grate. A series of vents are located along a circumference of the lower body, and a damper system is positioned outside of the lower body and in front of the series of vents. Advantageously, when horizontal airflow exterior to the lower body is introduced to an upper edge of the damper system, the airflow is directed in a downward direction toward the series of vents to enter the combustion chamber. Further, once the airflow enters the combustion chamber, it is split into parallel flows directed over and under the fuel grate. In certain embodiments, the airflow is split into parallel flows by an edge of the fuel grate itself, although it is envisioned that other features within the lower body may be positioned for splitting the airflow. Moreover, although a preferred embodiment splits the incoming airflow into the parallel flows directed over and under the fuel grate, it is envisioned that other embodiments of the solution may avoid splitting the katabatic airflow in favor of directing a single flow over the top (or beneath) the combusting coal bed.

Returning to the exemplary embodiment, the damper system may be operable to rotate relative to the lower body in order to control the volume of airflow introduced into the combustion chamber through the series of vents. And, an ash bowl component may be mated to the lower body and configured for removal and reattachment. The ash bowl component may feature handles for ease of handling. A lid associated with the upper body of the grill may include an adjustable damper, wherein adjustment of the lid damper provides for a controlled release of thermal energy and smoke from the cooking chamber defined by the upper body.

In some embodiments, the kettle-styled grilling system may comprise a collapsible support frame configured to support the kettle-styled grilling system and transition between a collapsed state and a deployed state. The support frame may include a handle, a pair of wheels, and one or more support feet configured to support the system in a vertical position when in the collapsed state. Additionally, the support frame may support a body component configured to define one or more storage capacities. One or more removable work surfaces may be associated with the body component.

In another exemplary embodiment of the solution, a method introduces a combustion-promoting airflow into a combustion chamber of a kettle-styled grill. The method comprises defining a series of vents in a side portion of a lower body of a kettle-styled grill, wherein the series of vents are positioned circumferentially around the lower body. Next, a fuel grate is positioned within the combustion chamber and substantially on plane with the series of vents. And, a damper system is positioned exterior to the lower body and in front of the series of vents, wherein the damper system defines a tortuous airflow path from an upper edge of the damper system that is positioned above the series of vents down to a lower edge of the damper system that is adjacent to the lower body and the series of vents. And, wherein, when an airflow in an ambient environment to the kettle-styled grill contacts the upper edge of the damper system, the airflow is encouraged down and through at least a portion of the series of vents to enter the combustion chamber. And, further, wherein upon entering the combustion chamber, the airflow is divided into parallel airflows such that a first of the parallel airflows is directed over the fuel grate and a second of the parallel airflows is directed beneath the fuel grate. The airflow may be split into parallel airflows by an edge of the fuel grate. Moreover, the damper system may be operable to rotate relative to the lower body in order to control the volume of airflow introduced into the combustion chamber through the series of vents. The method may further comprise including an ash bowl component mated to the lower body and configured for removal and reattachment.

As another example of the novel solution, a system for introducing a combustion-promoting airflow into a combustion chamber of a kettle-styled grill may comprise means for defining a series of vents in a side portion of a lower body of a kettle-styled grill, wherein the series of vents are positioned circumferentially around the lower body. The system may further comprise means for positioning a fuel grate within the combustion chamber and substantially on plane with the series of vents, as well as means for positioning a damper system exterior to the lower body and in front of the series of vents, wherein the damper system comprises means for defining a tortuous airflow path from an upper edge of the damper system that is positioned above the series of vents down to a lower edge of the damper system that is adjacent to the lower body and the series of vents. Advantageously, when an airflow in an ambient environment to the kettle-styled grill contacts the upper edge of the damper system, the airflow is encouraged down and through at least a portion of the series of vents to enter the combustion chamber, and, wherein upon entering the combustion chamber, the airflow is divided into parallel airflows such that a first of the parallel airflows is directed over the fuel grate and a second of the parallel airflows is directed beneath the fuel grate.

### BRIEF DESCRIPTION OF THE DRAWINGS

FIGS. 1A-1B are close-up illustrations of an exemplary embodiment of the solution for an improved portable grill system with katabatic dampers; and

FIGS. 2A-2C illustrate the exemplary embodiment of an improved portable grill system with katabatic dampers of FIG. 1, shown embodied in an exemplary portable grilling system that can be transitioned from a collapsed state, ready for relocation, to a deployed state ready for cooking.

### DETAILED DESCRIPTION

Various embodiments, aspects and features of the present invention encompass an improved portable grill system with katabatic dampers. Further configurations and advantages and uses of the solution will occur to those of skill in the art reviewing the figures and description. Generally, the present invention relates to systems and methods for portable grilling and, more particularly, to a novel and improved portable grilling system that leverages katabatic airflows into, across, and beneath a coal bed. Embodiments of the solution may also include a pluggable chimney configured for advantageous smoke management, as well as other novel and useful features.

As will become understood by one of ordinary skill in the art reviewing the figures and related description of this disclosure, embodiments of the solution leverage the relatively cooler ambient air of an outdoor grilling application, which often is presented to a grill in use via a breeze or wind. The solution promotes the cooler ambient air into an incoming airflow that is directed into a kettle-styled grill to efficiently and evenly promote combustion of a burning solid fuel therein. Advantageously, the airflow washes over and beneath a coal bed. Embodiments of the solution accomplish the feat by providing a damper feature located on the sides of the lower kettle of the grill (as opposed to beneath the lower kettle, as is known in the prior art) that presents a somewhat high-to-low torturous path into the combustion space of the grill, thereby increasing the velocity of the incoming air flow into and through the cooking chamber. And so, in reference to the above, the term “katabatic” is used in this description to refer to the unique airflow that is generated by, and promoted by, the features and structures of the inventive solution that enable a relatively cooler ambient air movement outside a kettle-styled grill to be encouraged into the lower body of the grill for efficient promotion of fuel combustion.

In this description, the term “coal bed” is used to generally refer to a bed of combusting solid fuel within a grill and is not meant to suggest that embodiments of the solution are only applicable in kettle-styled grills fueled by coal. As such, one of ordinary skill in the art will recognize that, in the context of the solution described herein, the term “coal bed” encompasses any solid fuel source, or combination of solid fuel sources, that may be used in an outdoor grilling application such as, but not limited to, coal, lump coal, wood chips, wood chunks, pellets, etc.

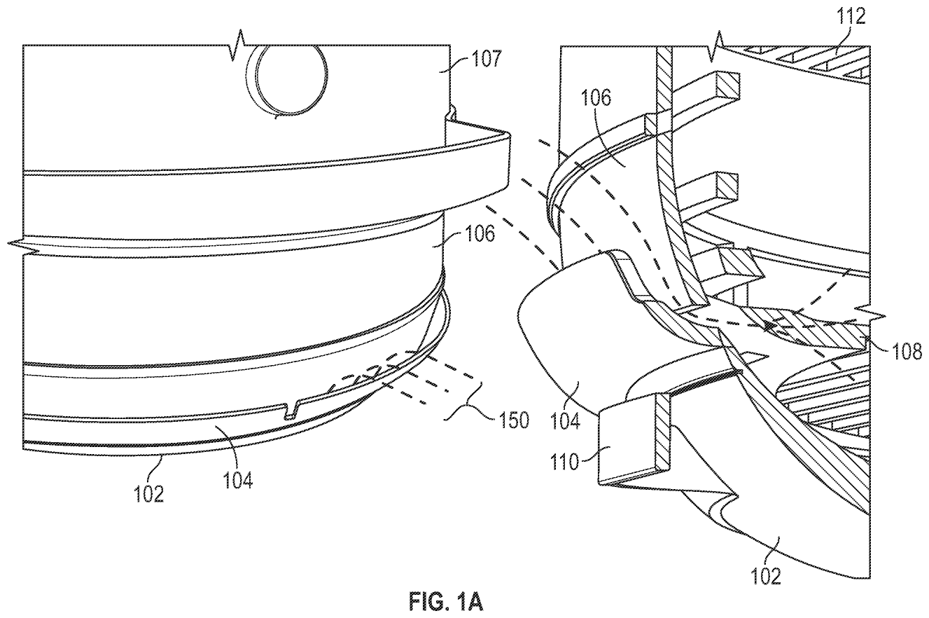

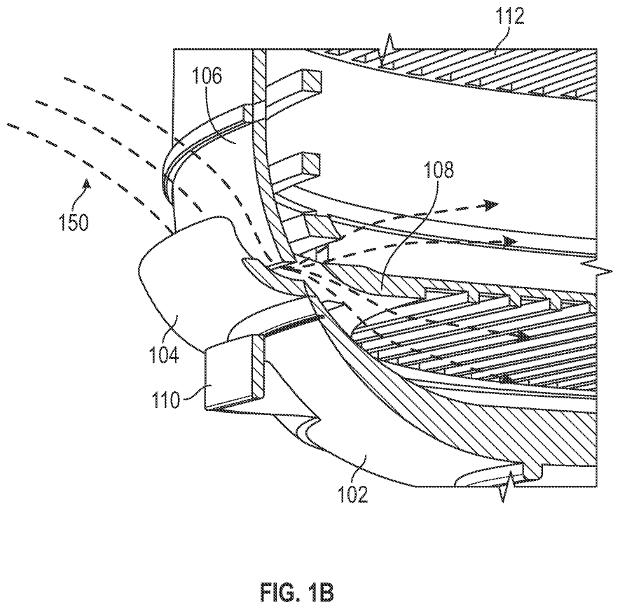

Referring to FIGS. 1A-1B, illustrated are close-up views of an exemplary embodiment of the solution for an improved portable grill system with katabatic dampers 104. FIGS. 1A-1B will be described simultaneously. As can be understood from the illustrations, the lower body 106 of the grill houses a cooking grate 112 and a fuel grate 108. Beneath the fuel grate 108 is an ash bowl component 102 that mechanically mates to the lower grill body 106 and may be configured for removal and reattachment (in order to discard collected ash) using handles 110. Although not shown in the illustrations, solid fuel such as charcoal, i.e. a “coal bed,” may be combusted on the fuel grate 108, as would be understood by one of ordinary skill in the art. Thermal energy and smoke resulting from combusting the fuel on the fuel grate rises to the cooking grate 112 and thereby “cooks” any foodstuff residing thereon before exiting the grill through dampers or a chimney in the grill lid (not shown in the illustration), as would also be understood by one of ordinary skill in the art.

Advantageously, katabatic dampers 104 are associated with vents into the lower grill body 106 that are substantially aligned with the fuel grate 108. In this way, the vents and their katabatic dampers 104 are positioned around the circumference of the lower grill body 106 such that ambient air (represented by dotted lines 150 in the illustrations) entering through the vents is directed to transverse both over and beneath the fuel grate 108, thereby promoting efficient combustion of the coal bed on the grate 108 and mitigating the occurrence of hot spots. The shape of the katabatic dampers 104 exterior to the grill body 106 creates a nonlinear path (a high-to-low path entering the grill body 106, and a low-to-high path exiting the grill body 106 at a point distal to the point of entry) for airflow entry that advantageously encourages ambient air flows to increase in velocity when entering the grill body 106, thereby increasing the volume of air that may be brought into the combustion chamber of the lower grill body 106 when compared to prior art solutions. A circumferential sliding adjustment of the katabatic dampers 104 may increase or reduce the vent openings in order to allow a user to control the amount of air allowed into the combustion chamber.

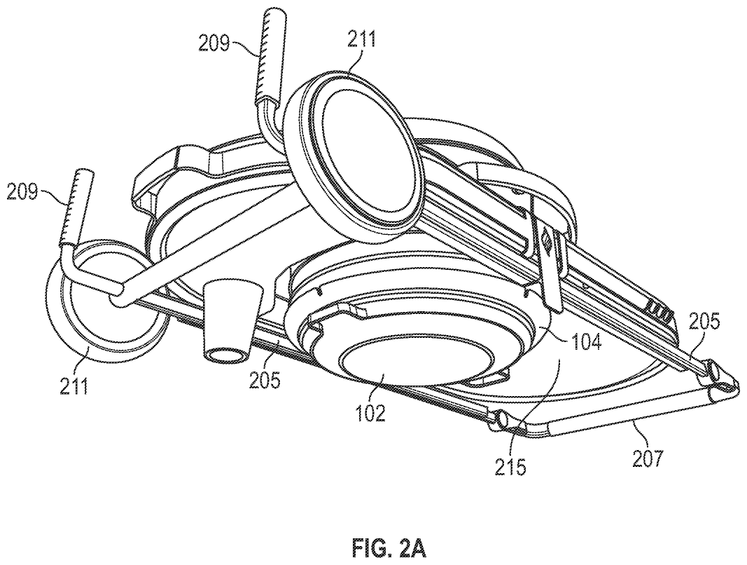

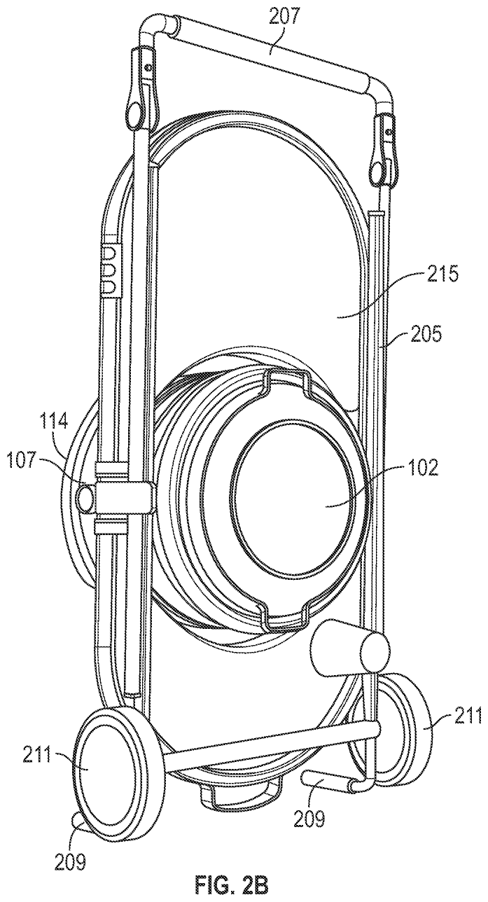

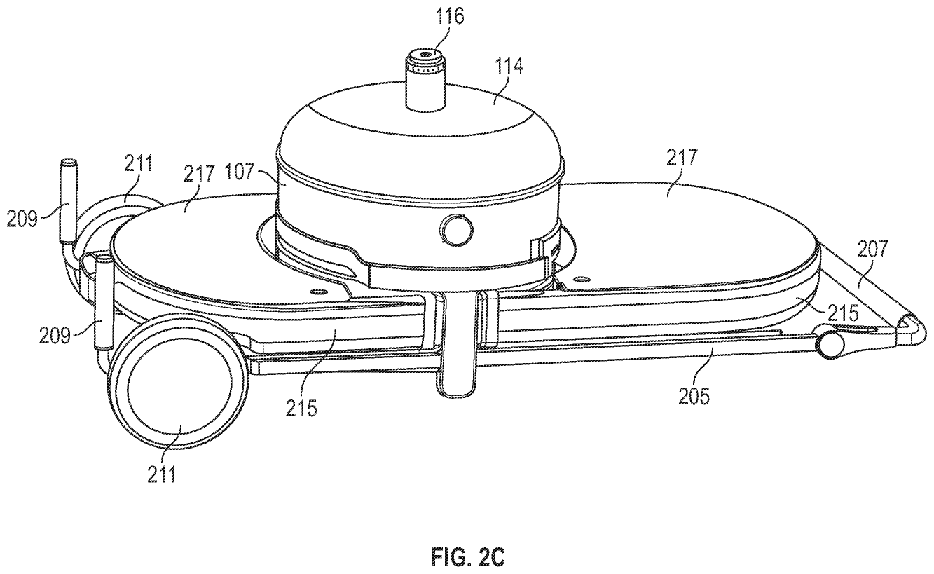

As can be understood from the illustrations, particularly the “cutaway” illustrations in FIGS. 1A-1B, the vents are located in the side of the lower grill body 106, behind the katabatic dampers 104, and circumferentially around the lower grill body 106. The airflow 150 “chokes down” at the vent, thereby increasing velocity in an inverse relation to a loss in energy occurring from the reduction in size of the flow path created by the vent, as would be understood by one of ordinary knowledge in physics. In this way, the relatively cooler ambient air which may approach the grill body 106 via ambient air movement is encouraged by the katabatic dampers 104 to “fall” toward the vents in the side of the grill body 106 and further increase velocity as it transverses through the vent into the interior of the lower grill body 106. Once in the grill body 106, the airflow 150 is met with an edge of fuel grate 108 such that the airflow 150 is split into parallel flows—an upper flow across the top of a combusting coal bed and a lower flow across the bottom of the combusting coal bed. In this way, the airflow 150 is efficiently introduced to the combusting coal bed to promote combustion. Some of the airflow 150, heated by the combusting coal bed, rises to the cooking grate 112, into the upper grill body 107 and out a damper/vent system 116 located at the top of the lid 114 (see FIG. 2C illustration). The remainder of the airflow 150 may exit the lower grill body 106 via a vent on the opposite side of the grill from where the air flow 150 earlier entered. Notably, backpressure generated by the vents and katabatic dampers 104 on said opposite side of the grill may slow the exit of the airflow 150 in order to better control the rate of combustion of the coal bed and the amount of smoke and thermal energy directed to the cooking grate 112.

FIGS. 2A-2C illustrate the exemplary embodiment of an improved portable grill system with katabatic dampers of FIG. 1, shown embodied in an exemplary portable grilling system that can be transitioned from a collapsed state, ready for relocation, to a deployed state ready for cooking. When collapsed, the exemplary embodiment of a portable grill system may be easily “rolled” or “pulled” from one location to another and then deployed into a usable state for grilling. FIGS. 2A-2C will be described simultaneously.

As can be understood from the FIGS. 2A-2C illustrations, a kettle-styled grill featuring a katabatic damper 104 and vent system is featured mounted in a collapsible support framework or chassis 205. The exemplary framework 205 features a scissor action for transitioning from a collapsed state (as shown in the illustrations) to a deployed state that positions the grill for use. The frame 205, when in the collapsed state, includes a handle 207 on one end and a set of wheels 221 on the distal end. Additionally, proximate to the wheels 211, a pair of foot features 209 are operable to support the grilling system in an upright position while in its collapsed state (as illustrated in FIG. 2B).

The frame 205 supports not only the grill with katabatic dampers, but also body 215 that defines storage cavities on either side of the grill that are capped by removable surfaces 217. The storage cavities within the body 215 may be used for storage of grilling accessories and other useful items. When deployed, the removable surfaces 217 may be used as a work surface.

A system and method of use for a new and useful improved portable grill system with katabatic dampers has been described using detailed descriptions and illustrations of embodiments thereof that are provided by way of example and are not intended to limit the scope of the disclosure. The described embodiments comprise different features, not all of which are required in all embodiments of the solution. Some embodiments of the solution utilize only some of the features or possible combinations of the features. Variations of embodiments of the solution that are described and illustrated, and embodiments of the solution comprising different combinations of features noted in the described and illustrated embodiments, will occur to persons of the art. It will be appreciated by persons skilled in the art that an improved portable grill system with katabatic dampers according to the solution is not limited by what has been particularly shown and described herein above. Rather, the scope of the disclosed solution is defined by the claims that follow.

What is claimed is:

1. A katabatic kettle-styled grilling system comprising:
a kettle having an upper body and a lower body, wherein the lower body defines a combustion chamber;
a fuel grate mounted within the combustion chamber;
a series of vents located along a circumference of the lower body; and
a damper system positioned outside of the lower body and in front of the series of vents;
wherein, when a horizontal airflow exterior to the lower body is introduced to an upper edge of the damper system, the airflow is directed in a downward direction toward the series of vents to enter the combustion chamber; and
wherein, when the airflow enters the combustion chamber, it is split into parallel flows directed over and under the fuel grate.

2. The katabatic kettle-styled grilling system of claim 1, wherein the airflow is split into parallel flows by an edge of the fuel grate.

3. The katabatic kettle-styled grilling system of claim 1, wherein the damper system is operable to rotate relative to the lower body in order to control the volume of airflow introduced into the combustion chamber through the series of vents.

4. The katabatic kettle-styled grilling system of claim 1, further comprising an ash bowl component mated to the lower body and configured for removal and reattachment.

5. The katabatic kettle-styled grilling system of claim 4, wherein the ash bowl component further comprises one or more handles.

6. The katabatic kettle-styled grilling system of claim 1, further comprising a lid with an adjustable damper, wherein adjustment of the lid damper provides for a controlled release of thermal energy and smoke from a cooking chamber.

7. The katabatic kettle-styled grilling system of claim 1, further comprising a collapsible support frame configured to support the kettle-styled grilling system and transition between a collapsed state and a deployed state.

8. The katabatic kettle-styled grilling system of claim 7, further comprising a handle, a pair of wheels, and one or more support feet configured to support the system in a vertical position when in the collapsed state.

9. The katabatic kettle-styled grilling system of claim 7, further comprising a body component configured to define one or more storage capacities.

10. The katabatic kettle-styled grilling system of claim 9, further comprising one or more removable work surfaces.

11. A method for introducing a combustion-promoting airflow into a combustion chamber of a kettle-styled grill, the method comprising:
defining a series of vents in a side portion of a lower body of a kettle-styled grill, wherein the series of vents are positioned circumferentially around the lower body;
positioning a fuel grate within the combustion chamber and substantially on plane with the series of vents;
positioning a damper system exterior to the lower body and in front of the series of vents, wherein the damper system defines a tortuous airflow path from an upper edge of the damper system that is positioned above the series of vents down to a lower edge of the damper system that is adjacent to the lower body and the series of vents;
wherein when an airflow in an ambient environment to the kettle-styled grill contacts the upper edge of the damper system, the airflow is encouraged down and through at least a portion of the series of vents to enter the combustion chamber; and
wherein upon entering the combustion chamber, the airflow is divided into parallel airflows such that a first of the parallel airflows is directed over the fuel grate and a second of the parallel airflows is directed beneath the fuel grate.

12. The method of claim 11, wherein the airflow is split into parallel airflows by an edge of the fuel grate.

13. The method of claim 11, wherein the damper system is operable to rotate relative to the lower body in order to control the volume of airflow introduced into the combustion chamber through the series of vents.

14. The method of claim 11, further comprising including an ash bowl component mated to the lower body and configured for removal and reattachment.

15. The method of claim 14, wherein the ash bowl component further comprises one or more handles.

16. A system for introducing a combustion-promoting airflow into a combustion chamber of a kettle-styled grill, the system comprising:
means for defining a series of vents in a side portion of a lower body of a kettle-styled grill, wherein the series of vents are positioned circumferentially around the lower body;
means for positioning a fuel grate within the combustion chamber and substantially on plane with the series of vents;
means for positioning a damper system exterior to the lower body and in front of the series of vents, wherein the damper system comprises means for defining a tortuous airflow path from an upper edge of the damper system that is positioned above the series of vents down to a lower edge of the damper system that is adjacent to the lower body and the series of vents;
wherein when an airflow in an ambient environment to the kettle-styled grill contacts the upper edge of the damper system, the airflow is encouraged down and through at least a portion of the series of vents to enter the combustion chamber; and
wherein upon entering the combustion chamber, the airflow is divided into parallel airflows such that a first of the parallel airflows is directed over the fuel grate and a second of the parallel airflows is directed beneath the fuel grate.

17. The system of claim 16, wherein the airflow is split into parallel airflows by an edge of the fuel grate.

18. The system of claim 16, wherein the damper system further comprises means for rotating relative to the lower body in order to control the volume of airflow introduced into the combustion chamber through the series of vents.

19. The system of claim 16, further comprising means for including an ash bowl component mated to the lower body and configured for removal and reattachment.

20. The system of claim 19, wherein the ash bowl component further comprises one or more handles.
